(19) United States
(12) Patent Application Publication
(10) Pub. No.: US 2011/0124514 A1
(43) Pub. Date: May 26, 2011

(54) Protein Signature Evaluation Platform

(75) Inventors: Carol E. Zhou, Pleasanton, CA (US); Adam T. Zemla, Brentwood, CA (US); Marisa W. Lam, Pleasanton, CA (US); Jason R. Smith, Mountain House, CA (US); Elizabeth A. Vitalis, Livermore, CA (US); Shea N. Gardner, Oakland, CA (US); Thomas A. Kuczmarski, Madison, WI (US); Thomas R. Slezak, Livermore, WI (US); Diane C. Roe, Newark, CA (US); Joseph P. Schoeniger, Oakland, CA (US); Clinton L. Torres, Pleasanton, CA (US)

(73) Assignee: LAWRENCE LIVERMORE NATIONAL SECURITY, LLC, Livermore, CA (US)

(21) Appl. No.: 12/051,765

(22) Filed: Mar. 19, 2008

Related U.S. Application Data
(60) Provisional application No. 60/919,070, filed on Mar. 19, 2007.

(51) Int. Cl. C40B 30/02; C40B 40/10

(52) U.S. Cl. 506/8; 506/18

(57) ABSTRACT

A set of known protein sequences associated with an organism is identified, wherein each known protein sequence comprises a plurality of ordered residues. A set of scores associated with a set of residues of the plurality of ordered residues is identified, wherein each score indicates a frequency of a residue in sequence context. A set of unique sub-sequences of the set of known protein sequences is identified. A plurality of protein signature residues is determined based on the set of scores associated with the set of residues and the set of unique sub-sequences.

### CROSS REFERENCE TO RELATED APPLICATION

This Application claims the benefit of Provisional Application No. 60/919,070 filed Mar. 19, 2007, the disclosure of which is hereby incorporated by reference, in its entirety for all purposes.

### STATEMENT REGARDING FEDERALLY FUNDED RESEARCH

This invention was made in the course of or under prime Contract No. DE-AC52-07NA27344 between the U.S. Department of Energy and Lawrence Livermore National Security, LLC. This Record of Invention is prepared for the Office of the Assistant General Counsel for Patents, U.S. Department of Energy.

### BACKGROUND OF THE INVENTION

1. Field of Invention

The present invention relates to the field of bioinformatics. More specifically, the invention relates to computational methods of identifying protein signatures to uniquely identify an organism.

2. Background of the Invention

A motif or signature is a defined region on a target protein that may be used to specifically identify that protein or, indirectly, the organism that produces it. There is an increased need to rapidly develop highly specific detection assays for organisms which cause biological threat. The identification of signatures specific to organisms of interest such as those associated with pathogens or toxins produced by an organism allows the rapid development of detection assays.

Non-computational methods of identifying protein signatures for high-affinity ligand-based detection include generation of antibodies to whole organisms, whole proteins or peptides. Non-computational methods of identifying protein signatures for reagent development include screening of compounds. In addition to being costly and time-consuming, non-computational methods are based on the principle of discovery and provide no a priori quantitative characterization of the protein residues forming the signature. Consequently, traditional methods based on, e.g., antibody generation or compound library screens provide little information that can be used for down-selecting or targeting the possible pool of reagents. In addition, if an antibody binds to a protein, it is possible that only a subset of residues within the protein bind the antibody, and further experimentation is required to find the residues responsible for antibody binding.

Current computational methods for identifying protein signatures are largely based on the analysis of conservation through multiple sequence alignment. Residue conservation is an indirect measure of functional or structural importance. Sequence alignments are carried out using utilities such as, e.g., BLAST (available from the National Center for Biotechnology Information website). From such sequence alignments, residues that are conserved within a set of proteins can be identified. Despite the power of techniques which use conservation for generating protein signatures or motifs, they suffer from several shortcomings.

Although signatures based on conservation can often indicate areas that are functionally or structurally important, such signatures are not always specific to a protein or organism of interest. For example, residues found in functional domains such as the basic leucine zipper domain are conserved. However, basic leucine zipper domains are found in large numbers of proteins and therefore cannot be used to generate a signature which specifically identifies a given protein or organism. Also, methods based on conservation require the a priori knowledge of a group of close homologs or proteins, information which often is unavailable. Further, residues that are conserved in a protein from one organism are also conserved in their homologs and by definition not unique to the organism. Similarly, residues that are conserved within a group of proteins structures with different functional characteristics are not unique to a set of proteins with the same functional characteristic.

Further, methods using multiple sequence alignment generally produce signatures of contiguous residues which may not have proximity in three-dimensional space or may not be found on the surface of a protein, thereby failing to form a signature for reagent or ligand development. Therefore, the evaluation of a measure of specificity for individual residues would be beneficial as it would allow further analyses based on structure.

Accordingly, improved methods of identifying protein signatures for organisms are needed.

### SUMMARY OF THE INVENTION

The above and other needs are met by systems and computer program products for identifying a set of protein signatures specific to an organism of interest.

One aspect provides a method of selecting a set of protein signature residues for an organism. A set of known protein sequences associated with an organism is identified, wherein each known protein sequence comprises a plurality of ordered residues. A set of scores associated with a set of residues of the plurality of ordered residues is identified, wherein each score indicates a frequency of a residue in sequence context. A set of unique sub-sequences of the set of known protein sequences is identified. A plurality of protein signature residues is determined based on the set of scores associated with the set of residues and the set of unique sub-sequences.

Another aspect is embodied as a computer-readable storage medium encoded with computer program code for selecting a set of protein signature residues for an organism.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter, which is defined solely by the appended claims.

### BRIEF DESCRIPTION OF THE DRAWINGS

FIG. 1 is a high-level block diagram of a computing environment 100 according to one embodiment.

FIG. 2 is a block diagram illustrating a detailed view of a Protein Signature Engine 110 according to one embodiment.

FIG. 3 provides a conceptual illustration of the pScore algorithm.

FIG. 4 provides a conceptual illustration of the Uniquemer algorithm.

FIG. 5 is flowchart illustrating steps performed by the Protein Signature Engine 110 to identify protein signatures for an organism according to one embodiment.

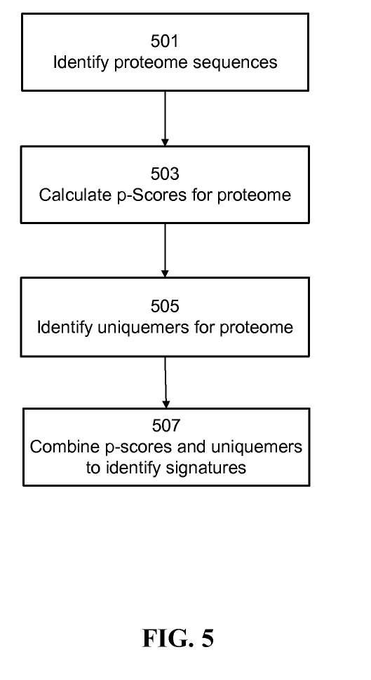

FIG. 6a tabulates results of applying the uniquemer and pScore algorithms to a set of protein sequences representing the proteome of Yesinia pestis. FIG. 6b tabulates the uniquemer residues and pScores identified for the protein sequence of putative F1 capsule anchoring protein, caf1A of Yersinia pestis.

FIGS. 7a-7c illustrate identified uniquemers, pScores and protein signatures relative to the three-dimensional protein structure of caf1A.

FIG. 8a tabulates results of applying the uniquemer and pScore algorithms to a set of protein sequences representing the proteome of the India 1967 strain of Variola virus. FIG. 8b tabulates results of applying the uniquemer algorithm to a set of protein sequences representing the proteome of the India 1967 strain of Variola virus.

FIGS. 9a-9c illustrate identified uniquemers, pScores and protein signatures relative to the three-dimensional protein structure of the D13L protein of Variola India 1967.

The figures depict various embodiments of the present invention for purposes of illustration only. One skilled in the art will readily recognize from the following discussion that alternative embodiments of the structures and methods illustrated herein may be employed without departing from the principles of the invention described herein.

### DEFINITIONS

Residue: An amino acid residue is one amino acid that is joined to another by a peptide bond. Residue encompasses the combination of an amino acid and its position in a polypeptide sequence, for example, D31 or A234.

Surface residue: A surface residue is a residue located on a surface of a polypeptide. A surface residue usually includes a hydrophilic side chain. Operationally, a surface residue can be identified computationally from a structural model of a polypeptide as a residue that contacts a sphere of hydration rolled over the surface of the molecular structure. A surface residue also can be identified experimentally through the use of deuterium exchange studies, or accessibility to various labeling reagents such as, e.g., hydrophilic alkylating agents.

Buried residue: A buried residue is a residue that is not located on the surface of a polypeptide. Buried residues usually include a hydrophobic side chain.

Organism: A species or a strain of a species.

Proteome: A set of protein sequences encoded by the genetic material (i.e., Ribonucleic Acid or Deoxyribose Nucleic Acid) of an organism. The proteome may contain all known protein sequences for an organism or a representative set of protein sequences for the organism.

Polypeptide: A single linear chain of 2 or more amino acids. A protein is an example of a polypeptide.

N-mer: A polypeptide of length n.

Uniquemer: A n-mer that is a sub-sequence of only one protein sequence (i.e., unique to a protein sequence) or an n-mer that is a sub-sequence of a set of protein sequences associated with only one organism (i.e., unique to an organism), a specified group of organisms (e.g., a genus), or a set of homologous protein sequences from different organisms (e.g., Stx1 shiga toxin).

Homolog: A gene related to a second gene by descent from a common ancestral DNA sequence. The term, homolog, may apply to the relationship between genes separated by the event of speciation or to the relationship between genes separated by the event of genetic duplication.

Taxonomy: The classification of organisms in an ordered system that indicates natural relationships. As discussed herein, taxonomy is a classification of organisms that indicates evolutionary relationships.

Conservation: Conservation is a high degree of similarity in the primary or secondary structure of molecules between homologs. This similarity is thought to confer functional importance to a conserved region of the molecule. In reference to an individual residue or amino acid, conservation is used to refer to a computed likelihood of substitution or deletion based on comparison with homologous molecules.

Distance Matrix: The method used to present the results of the calculation of an optimal pair-wise alignment score. The matrix field (i,j) is the score assigned to the optimal alignment between two residues (up to a total of i by j residues) from the input sequences. Each entry is calculated from the top-left neighboring entries by way of a recursive equation.

Substitution Matrix: A matrix that defines scores for amino acid substitutions, reflecting the similarity of physicochemical properties, and observed substitution frequencies. These matrices are the foundation of statistical techniques for finding alignments.

Gapped Alignment: An alignment wherein a space is introduced to compensate for insertions and deletions in one sequence relative to another.

Mismatch: A comparison of two protein molecules where the residues between the two molecules do not share identity at one position. In a single mismatch, all pairs of amino acid residues formed in the comparison between the two molecules are equivalent except for one pair.

Perfect Match: A comparison of two protein molecules where the residues between the two molecules have 100% identity at each position.

### DETAILED DESCRIPTION

The practice of the present invention will employ, unless otherwise indicated, conventional techniques of computational biology, biophysics, structural biology, evolutionary biology, molecular biology and biochemistry, which are within the skill of the art. Such techniques are explained fully in the literature, such as Singleton et al., Dictionary of Microbiology and Molecular Biology 2nd ed., J. Wiley & Sons (1994), Bourne et al., Structural Bioinformatics, J. Wiley & Sons (2002), Fogel et al., Evolutionary Computation in Bioinformatics, Morgan Kaufmann (2002) and Mount, Bioinformatics Sequence and Genome Analysis, Cold Spring Harbor Laboratory (2001).

As noted above, there is demand for a robust method of computationally determining protein signatures which provide the specific identification of an organism. Accordingly, the present invention provides a method for identifying protein subsequences and structure motifs that are unique to an organisms, i.e., “signatures,” for development of detection assays and therapeutics.

These methods are widely applicable for identification of signatures representative of regions suitable for development of diagnostic reagents for proteins expressed by pathogenic organisms or for development of therapeutic drugs or antibodies, and can reduce the time and cost of such efforts by identifying up front those regions that are optimal for reagent targeting in terms of specificity for the organism of interest and that pose the least risk in terms of cross-reactivity with other proteins from other organisms.

The residues comprising an identified signature can be projected onto a three-dimensional structure of the corresponding protein to evaluate the suitability of the signature for reagent development for, e.g., bio-threat detection. Such methods provide a way to identify regions on a protein that are surface exposed and amenable to binding by small molecule ligands or antibodies. Signatures comprising surface-exposed residues are preferred for targeted reagent development. Accordingly, the identification of signatures for an organism according to the methods of the invention finds use for development of reagents such as small chemical ligands or antibodies and assays using such reagents for highly specific target detection.

While the present method finds use in detecting any pathogen or target, preferred pathogens include but are not limited to, avian influenza, Ebola virus, dengue virus and the like. Others include SARS (coranavirus). Additionally, the same methods may be used for the detection of bacterial pathogens such as Bacillus anthracis, Escherichia coli, and Yersinia pestis. The method finds further use in the detection of plant-based toxins such as abrin and ricin.

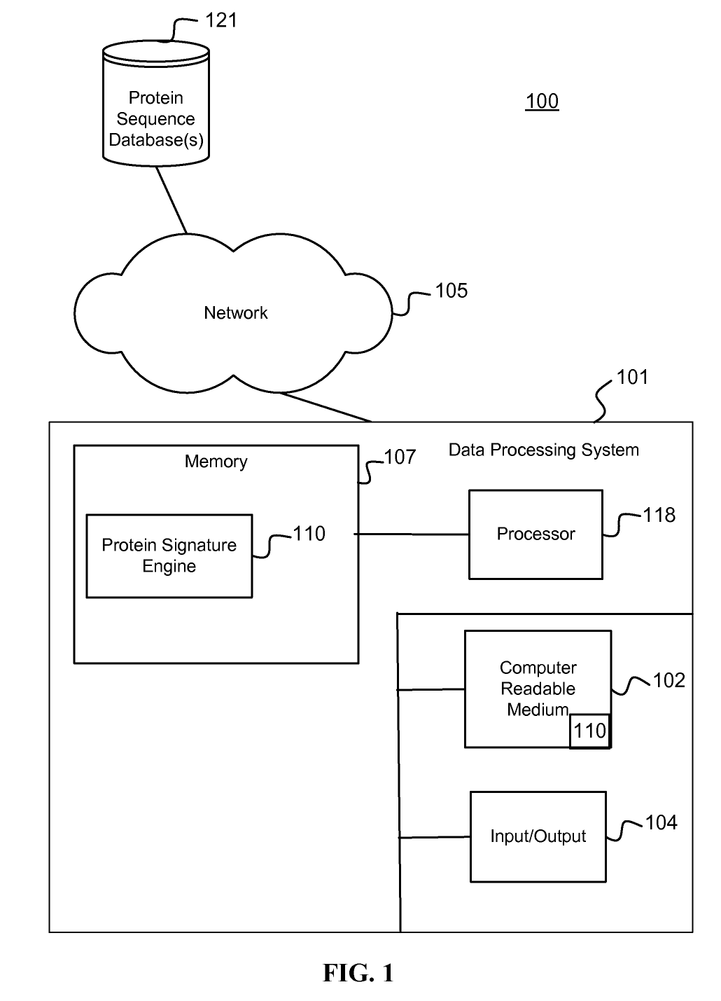

FIG. 1 shows a system architecture 100 adapted to support one embodiment of the present invention. FIG. 1 shows components used to identify signatures for an organism. The system architecture 100 includes a network 105, through which any number of Protein Sequence Database(s) 121 are accessed by a data processing system 101.

FIG. 1 shows component engines used to generate and characterize protein signatures for organisms. The data processing system 101 includes a Protein Signature Engine 110. The Protein Signature Engine 110 is implemented, in one embodiment, as software modules (or programs) executed by processor 118.

The Protein Signature Engine 110 operates to identify protein signatures for organisms by accessing the Protein Sequence Database(s) 121 through the network 105 (as operationally and programmatically defined within the data processing system). According to the embodiment, Protein Sequence Database(s) 121 may include the Non Redundant set of protein sequences (NR) (available at the website of the National Institute for Bioinformatics Information) and SwissProt (available at the website of the European Bioinformatics Institute). Other Protein Sequence Database(s) 121 are known to those skilled in the art.

It should also be appreciated that in practice at least some of the components of the data processing system 101 can be distributed over multiple computers, communicating over a network. For example, the Protein Signature Engine 110 may be deployed over multiple servers. As another example, the Protein Signature Engine 110 may be located on any number of different computers. For convenience of explanation, however, the components of the data processing system 101 are discussed as though they were implemented on a single computer.

In another embodiment, some or all of the Protein Sequence Database(s) 121 are located on the data processing system 101 instead of being coupled to the data processing system 101 by a network 105. For example, the Protein Signature Engine 110 may import protein sequences from Protein Sequence Database(s) 121 that are a part of or associated with the data processing system 101.

FIG. 1 shows that the data processing system 101 includes a memory 107 and one or more processors 118. The memory 107 includes the Protein Signature Engine 110. The Protein Signature Engine 110 is preferably implemented as instructions stored in memory 107 and executable by the processor 118.

FIG. 1 also includes a computer readable medium 102 containing the Protein Signature Engine 110. FIG. 1 also includes one or more input/output devices 104 that allow data to be input and output to and from the data processing system 101. It will be understood that embodiments of the data processing system 101 also include standard software components such as operating systems and the like and further include standard hardware components not shown in the figure for clarity of example.

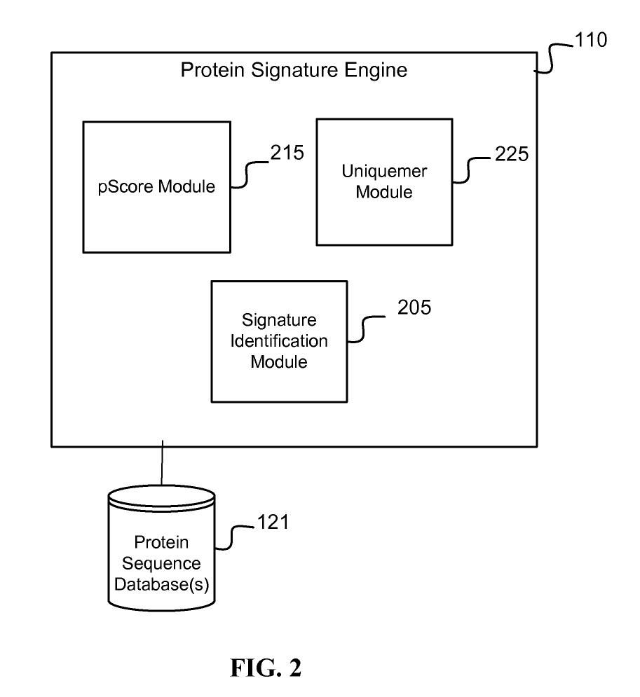

FIG. 2 is a block diagram illustrating a detailed view of a Protein Signature Engine 110 according to one embodiment.

The Protein Signature Engine 110 comprises a pScore Module 215, a Uniquemer Module 225 and a Signature Identification Module 205. The pScore Module 215 functions to generate pScores for residues in a set of one or more protein sequences. The Uniquemer Module 225 functions to identify uniquemers in the set of one or more protein sequences.

The Signature Identification Module 205 functions to select a set of one or more protein sequences representing the proteome of a specified organism from the Protein Sequence Database(s) 121 for signature analysis. In one embodiment, the Signature Identification Module 205 selects a set of sequences representing the proteome of an organism based on a query specified by a user. The Signature Identification Module 205 communicates with the pScore Module 215 and the Uniquemer Module 225 to generate pScores for the select set of protein sequences and identify uniquemers in the set of protein sequences. The Signature Identification Module 205 identifies uniquemer residues with pScores above a given threshold value to identify a set of protein signatures for the specified organism.

pScore

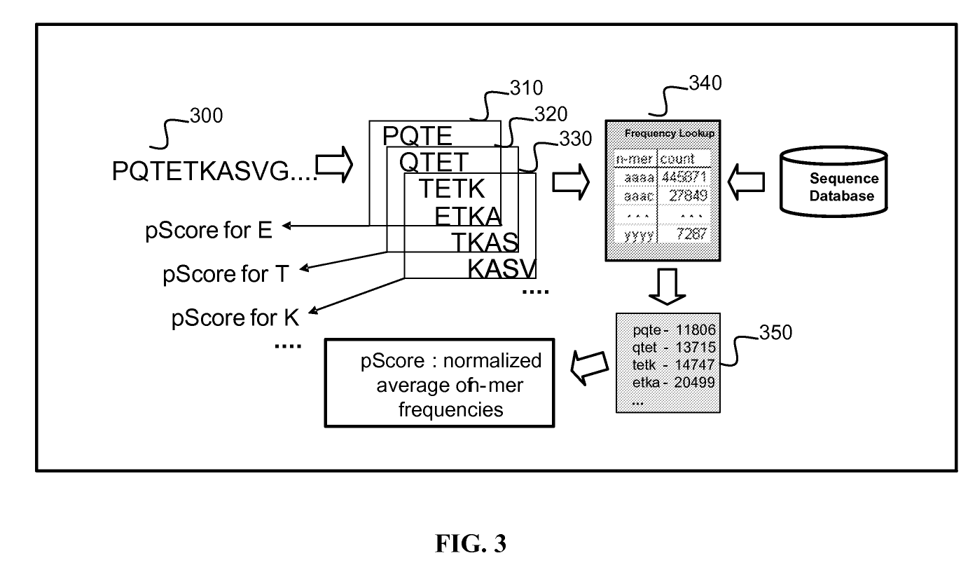

FIG. 3 provides a conceptual illustration of the pScore algorithm according to one embodiment of the present invention. The pScore Module 215 calculates for a score, i.e., a “pScore,” for one or more residues representative of the residue frequency in local sequence context. A scoring function maps an abstract concept to a numeric value. The pScore Module 215 generates pScores to assign a quantitative value to the specificity of a residue to a protein sequence relative to a dataset of sequence.

In the method of the present invention, the pScore Module 215 generates a set of sub-sequences 310, 320, 330 from a polypeptide sequence 300 which comprises a residue being scored. This set of sub-sequences can contain sub-sequences of different lengths. However, the majority of discussion of the present invention is directed to embodiments of the pScore Module 215 that generate a set of sub-sequence of the same length. These sub-sequences are herein referred to as n-mers, where n represents the number of residues in the sub-sequence. Depending on the application of the present experiment, the pScore Module 215 generates n-mers that are preferably 4, 5 or 6 residues in length. The full set of all amino acid n-mers generated to include a given residue will have n sub-sequences.

In some embodiments, the pScore Module 215 generates n-mers using a sliding window approach. A sliding window approach provides a way of generating all n-mers which include a given residue. In a sliding window approach, an n-mer of a fixed size is advanced one position in sequence to generate a set of n-mers, each adjacent n-mer differing by one residue.

For each n-mer in the set, the pScore Module 215 calculates occurrence frequencies based on the occurrence of the n-mer in a dataset of sequence. The occurrence frequency can be represented as number of occurrences of the n-mer in the dataset. The occurrence frequency can also be represented relative to the number of n-mers in the dataset or a subset of the dataset, for example, all sequences in the NR sequence database which are Flavivirus sequences. Various other methods of computing and representing the occurrence frequency value will be apparent to those skilled in the art having the benefit of the instant disclosure. The pScore Module 215 generates the pScores based on an occurrence frequency for a sub-sequence based on the occurrence of that sub-sequence in a dataset 340.

In one embodiment, the pScore Module 215 generates occurrence frequencies by generating a sequence alignment for each member of the set of n-mers. The pScore Module 215 can align each member of the set of n-mers against a dataset of sequences using any implementation of a sequence alignment algorithm (e.g., BLAST, BLAT, FASTA, HMMer). The sequence alignment algorithm can incorporate the use of gapped alignment or mismatches. Accordingly, the matches derived from the alignment may include perfect matches, mismatches and gapped alignments. These matches are used to generate an occurrence frequency. In the generation of an occurrence frequency, matches can be weighted based on the “goodness” of the match with perfect matches having a higher weight than mismatches or gapped alignments.

In one embodiment of the present invention, the pScore Module 215 identifies an occurrence frequency for an n-mer by searching a set of records. In this method, the pScore Module 215 calculates occurrence frequencies for the possible 20ⁿ amino acid n-mers sequences based on the dataset of all known n-mers and stores the occurrence frequencies. In one embodiment, the pScore Module 215 stores the occurrence frequencies as a set of records 340 containing the n-mers in association with their frequencies. In a specific embodiment, the pScore Module 215 stores these records in a searchable index of records 340. According to the embodiment, the pScore Module 215 updates these records to reflect changes in the dataset. These updates may happen at any time interval such as: daily, weekly or monthly or asynchronously.

In one application of the present invention, the pScore Module 215 generates occurrence frequencies 350 by searching records 340 only for perfect match sequences. Alternatively, the pScore Module 215 generates occurrence frequencies 350 by searching records for mis-matched sequences using defined mismatches or residue substitutions. In this embodiment, mis-matched sequences can be weighted relative to perfect matches to generate the occurrence frequency for the query sub-sequence.

Various configurations and architectures for storing and searching the records will be readily apparent to those with ordinary skill in the art. The records can be stored in a searchable index to facilitate lookup in any manner of ways. Additionally, the records may be searched using parallel processing to optimize the lookup process.

In a specific example, the frequencies of 20ⁿ amino acid n-mer sequences are calculated for n ranging from 1 to 6. The n-mer combinations are converted into a sorted bit counting array using binary shift operations. A flat-file fixed width index is used to speed up look-up time of a given n-mer frequency. Searches are conducted using BLOSUM matrices to pre-define allowable residue substitutions.

The pScore Module 215 combines the set of occurrence frequencies 350 to generate a pScore using a variety of methods. Combining designates any mathematical operation or combination of mathematical operations including, but not limited to adding, subtracting, multiplying, or dividing. The occurrence frequencies 350 for the set of n-mers can be averaged, that is summed and divided by n. Alternatively, a high or low occurrence frequency can be selected from the set of occurrence frequencies as the pScore.

The pScore Module 215 can normalize pScores using any combination of mathematical formulae and data derived from the polypeptide or the dataset of sequence. For example, when comparing across n sizes, pScores can also be normalized with a log function to remove skewing caused by distribution bias. The pScore Module 215 can normalize pScores relative to the distribution of the sub-sequences in a dataset or a pre-defined subset of the dataset.

In another embodiment, the pScore Module 215 can normalize the pScore for a residue in a polypeptide sequence relative to the set of other pScores calculated for the same polypeptide sequence. For example, maximum and minimum pScores for a given protein are determined and a normalized pScore is computed as:

pScoreₙₒₘ=1−((pScore_{original}−pScoreₘᵢₙ)/(pScoreₘₐₓ−pScoreₘᵢₙ)))

This method can be extended to include pScores generated for each residue in a set of proteins.

The pScore Module 215 combines pScores to provide a score representative of the overall specificity of local sequence in a protein. In one application of the present invention, the pScore Module 215 calculates and combines pScores by producing an average pScore value for a group of proteins. The calculated scores can then be used to rank proteins in the group relative to each other in order to select proteins as potential candidates from which to develop protein signatures for an organism.

In some embodiments of the present invention, the pScore Module 215 generates a summary file for each pScore from a protein or a set of proteins. The summary files describe the statistical spread of the pScore data. Statistics such as maximum pScore, average pScore, minimum and normalized pScore are provided in the summary file

### Uniquemer Algorithm

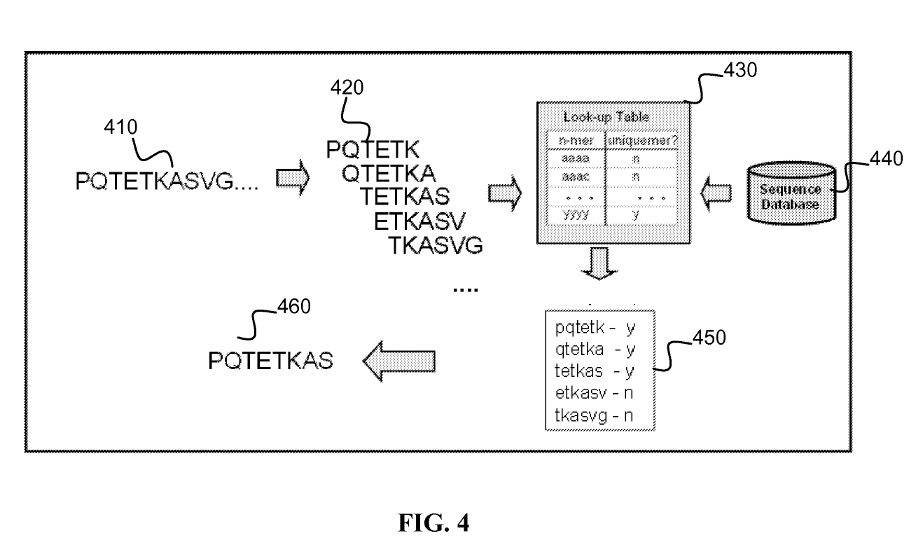

FIG. 4 provides a conceptual illustration of the Uniquemer algorithm, according to one embodiment. A protein sequence is identified 410. A set of sub-sequences is generated based on the protein sequence 420. A look-up table of uniquemers 430 is generated based on a protein sequence database 440 where each uniquemer 430 occurs in the database only once (i.e., only in one protein sequence) or only in a set of protein sequences from one organism. The generated set of sub-sequences is compared with the uniquemers in the lookup table to identify a subset of the sub-sequences that are uniquemers. This subset of sequences is compared to the original protein sequence to identify uniquemers in the protein sequences where all the sub-sequences of the uniquemer are also uniquemers.

The Uniquemer Module 225 generates a set of sub-sequences from the set of protein sequences. In one embodiment this set of sub-sequences can contain sub-sequences of different lengths. In other embodiments the set of sub-sequences in the set of protein sequences are of the same length. These sub-sequences are referred to as n-mers, where n represents the number of residues in the sub-sequence. Depending on the application of the present invention, the n-mers preferably are 4, 5 or 6 residues in length.

In one embodiment, the Uniquemer Module 225 generates the set of n-mers using a sliding window approach. A sliding window approach provides a way of generating all n-mers which include a given residue. In a sliding window approach, an n-mer of a fixed size is advanced one position in sequence to generate a set of n-mers, adjacent n-mers differing from another by one residue.

In one embodiment, the Uniquemer Module 225 evaluates the set of generated n-mers to identify which n-mers are uniquemers using a lookup table of uniquemers. The Uniquemer Module 225 further identifies all uniquemers of size greater than n, where n is equal to the size of the generated n-mers. The Uniquemer Module 225 identifies all uniquemers of size greater than n by identifying the start positions of the generated n-mers and determining a set of n-mers that have start positions that differ by one residue. The Uniquemer Module 225 then combines this set of n-mers to generate a uniquemer of length greater than n.

The Uniquemer Module 225 is adapted to communicate with the Protein Sequence Database(s) 121 to identify a set of non-redundant protein sequences that represent all known protein sequences for organisms. The Uniquemer Module 225 generates a lookup table 430 of uniquemers by identifying occurrence frequencies for a set of sub-sequences in the Protein Sequence Database(s) 121. An occurrence frequency the number of times a sub-sequence occurs in the set the specified Protein Sequence Database(s) 121. The Uniquemer Module 225 identifies sub-sequences in the Protein Sequence Database(s) 121 that have an occurrence frequency of one (i.e., are unique to a given sequence) or only occur in protein sequences associated with an organism (i.e., are unique to an organism) as uniquemers.

In a specific embodiment, the Uniquemer Module 225 generates occurrence frequencies using a suffix tree algorithm. Another suitable method of generating occurrence frequencies for a set of subsequences in a dataset of sequences comprises using a sliding window approach over the entire dataset of sequences to identify subsequences, generating a hash or dictionary with each identified subsequence as a key and increasing the count by one each time that n-mer is encountered, storing it as the hash value for that key. Occurrence frequencies may also be generated by generating a set of all possible n-mers and using a regular expression or other similarity search method to ascertain the frequencies of each n-mer. The Uniquemer Module 225 stores the uniquemers sub-sequences in a lookup table 430. In a specific embodiment, the Uniquemer Module 225 stores all possible sub-sequences of a specified length in the lookup table in association with an indicator which specifies whether or not they are uniquemers.

### Signature Identification

According to certain embodiments of the present invention, the calculation of pScores and uniquemers provides information used in the identification of a subset of residues that form a protein signature. In one embodiment, the Signature Identification Module 205 identifies the uniquemer residues with high pScores as protein signatures. The combination of pScores representing frequency in local sequence context of each residue and the uniquemers representing residues that are in sub-sequences unique to a protein sequence allows for the identification of protein signature residues that can be used to uniquely identify an organism. In one embodiment, the uniquemer residues with high pScores are automatically identified by the Signature Identification Module 205 and displayed relative to one or more protein sequences.

In another embodiment, the Signature Identification Module 205 further combines the uniquemer residues with high pScores with a score that indicates a probability that a residue is on the surface of the three-dimensional structure of a protein. This added information aids in finding residues that are surface exposed and amenable to binding by small molecule ligands or antibodies. It is well known to those of ordinary skill in the art how to assign a probability associated with the likelihood that a residue is a surface residue. Examples of ways to obtain such probabilities include, e.g., computational algorithms such as those implemented in PredictProtein (Rost and Liu, 2003). Another method of predicting surface accessible residues incorporates the use or creation of a three-dimensional model of the protein structure.

In some embodiments of the present invention, the Signature Identification Module 205 displays uniquemer residues with high pScores onto a three-dimensional representation of a polypeptide to identify a set of high scoring residues on the surface of the protein which are proximate in three-dimensional space. This display is used to identify a set of residues which define a protein signature that can be used in reagent development. Sets of residues proximal in three-dimensional space (i.e., within a radius of 10 to 20 Angstroms) may represent functional binding sites of the protein such as epitopes or binding sites for therapeutic agents. This set can contain any number of residues but in most embodiments will be three or more residues, such as, e.g., three, four, five, six, seven, eight, nine, ten, or more residues. In alternate embodiments, unique residues with high pScores that are proximate in three-dimensional space can be identified computationally.

In one embodiment, the Signature Identification Module 205 displays on the three-dimensional representation only uniquemer residues with pScores above or below a threshold pScore value. In another embodiment, residues are colored according to pScore. In another embodiment, the Signature Identification Module 205 displays the uniquemer residues having pScores above or below a certain pScore value along with other scores representative of other data such as structural conservation or the uniqueness of a residue relative to a set of confounders.

According to the application of the present invention, various programs for rendering the three-dimensional display of a protein from a set of atom coordinates are employed in this method. RasMol is a common program for molecular graphics visualization. Other programs used to visualize three-dimensional protein structures include Chime and Protein Explorer.

In another embodiment, the pScores and uniquemer residues are used to generate a signature comprising a sub-sequence including uniquemer residues with pScores above a threshold value. A threshold pScore value may be specified to filter for stretches of contiguous uniquemer residues having pScores that are above the threshold value. For example, if scores are normalized to a value between one and zero, the threshold value may be set to 0.5, 0.6, 0.7, 0.75, 0.8, 0.85, 0.9, or 0.95. Alternatively, the threshold value may be based on a percentile cutoff based on a distribution of pScores for residues in one or more proteins.

In one embodiment, the Signature Identification Module 205 projects the uniquemer residues having pScores above or below a given threshold value onto a linear representation of the two-dimensional amino acid sequence to visualize signatures comprising residues contiguous in a linear (i.e., primary) sequence.

In one embodiment, the scores are displayed as a line graph having the amino acid sequence plotted along the x-axis and the numeric values of the scores plotted on the y-axis. The scores can also be displayed on the y-axis along with other scores including, but not limited to, scores representative of residue frequency in local sequence context. In some embodiments, the scores can be represented by coloring the residues in the correspondence or by other visualization techniques.

### EXAMPLE 1

### Identification of Signatures in Yersinia pestis

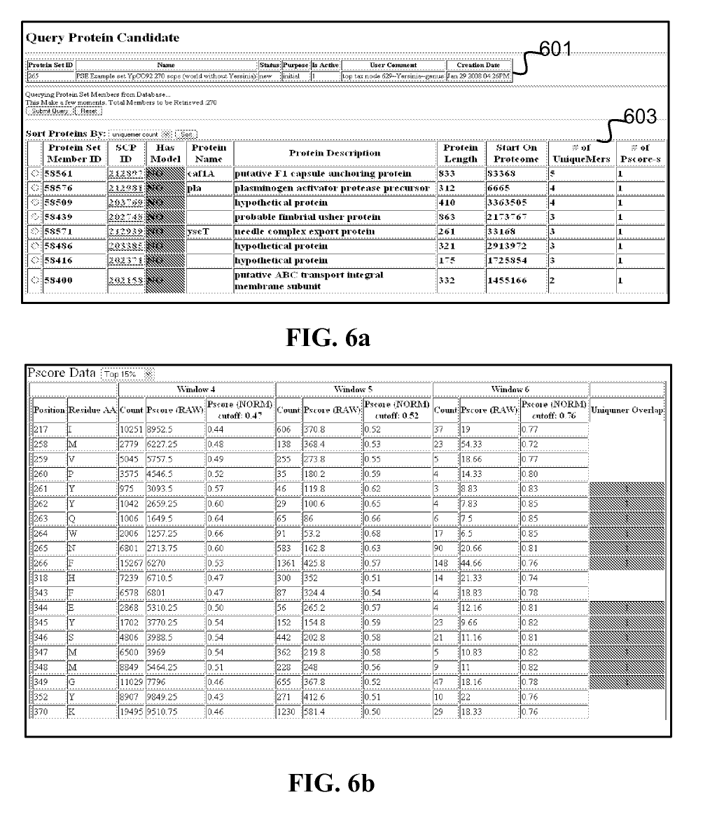

FIG. 6a tabulates results of applying the uniquemer and pScore algorithms to a set of protein sequences representing the proteome of Yesinia pestis. In this example, a query 601 was performed to select a set of protein sequences representing the proteome of Yersinia pestis. Uniquemer and pScore analysis was then applied to the set of protein sequences representing the proteome of Yersinia pestis to select a set of protein sequences containing uniquemers and residues with pScores above a specified threshold value. The set of Yersinia pestis protein sequences 603 was sorted according to the number of uniquemers identified in each protein sequence.

FIG. 6b tabulates the uniquemer residues and pScores identified for the protein sequence of putative F1 capsule anchoring protein, caf1A of Yersinia pestis. The amino acid symbols of the residues in the calf1A protein sequence are displayed in the second column of the table. The position of each residue in the caf1A protein sequence is displayed in the first column of the table. In the table, pScores are displayed and colored according to three different cutoff criteria in three different windows. Window 4 displays normalized pScores calculated using 4-mers that are higher than a cutoff value of the 15^{th} percentile of all pScores (0.53) in light gray. Window 5 displays normalized pScores calculated using 4-mers that are higher than a cutoff value of the 15^{th} percentile of all pScores (0.56) in light gray. Window 6 displays normalized pScores calculated using 5-mers that are higher than a cutoff value of the 15^{th} percentile of all pScores (0.69) in light gray. The residues which are in subsequences of caf1A identified to be uniquemers are indicated and colored in dark gray in the column labeled ‘Uniquemer Overlap’. Using the visualization of normalized pScore and uniquemer residues in FIG. 6b, protein signatures specific to Yersinia pestis comprising uniquemer residues with high pScores can be identified.

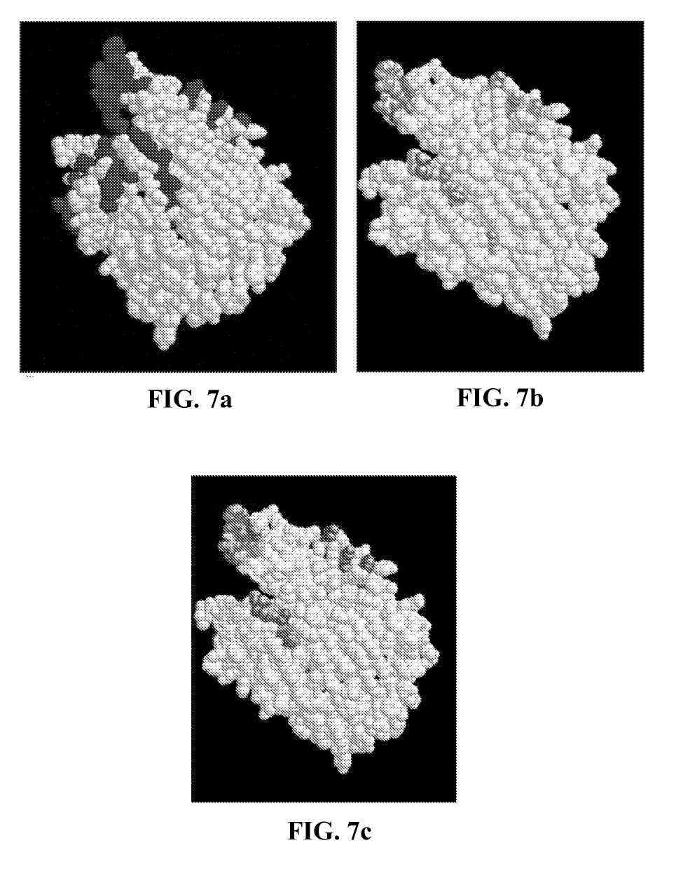

FIGS. 7a-c illustrate the identified uniquemers, pScores and protein signatures relative to the three-dimensional protein structure of caf1A. The protein structure of caf1A was modeled using the homology-based protein structure modeling system AS2TS (Zemla et al., 2005). The uniquemer residues and residues with pScores calculated using 4-mers that are within the tope 15^{th} percentile of pScores (tabulated in FIG. 6b) are visualized on the surface of three-dimensional protein structure. In FIG. 7a, the residues with normalized pScores calculated using 4-mers that are within the top 15^{the} percentile are shaded in gray on the caf1A protein structure. In FIG. 7b, uniquemer residues are shaded in gray on the caf1A protein structure. In FIG. 7c, protein signatures comprising uniquemer residues with normalized pScores calculated using 4-mers that are within the top 15^{the} percentile of the calculated pScores shaded in gray.

Visualization of surface-exposed regions containing residues with uniquemers was facilitated using RasMol (Sayle and Milner-White, 1995) to color uniquemer residues. Uniquemers and residues with pScores above the specified threshold value were loaded into the b-factor column of the reference caf1A 3D coordinates file and displayed using RasMol's color-temperature setting.

### EXAMPLE 2

### Identification of Signatures in the Indian 1967 Strain of Variola Virus

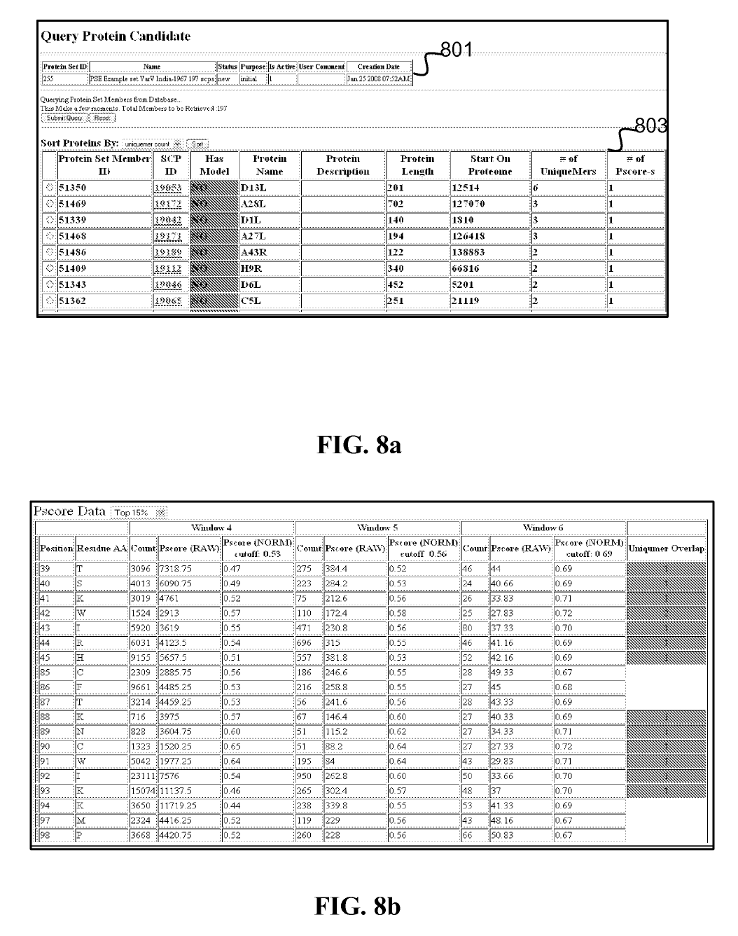

FIG. 8a tabulates results of applying the uniquemer algorithm to a set of protein sequences representing the proteome of the India 1967 strain of Variola virus (“Variola India 1967”). In this example, a query 801 was made to select a set of protein sequences representing the proteome of Variola India 1967. Uniquemer analysis was then applied to the set of protein sequences representing the proteome of Variola India 1967 to select a set of protein sequences containing uniquemers 803. The set of protein sequences containing uniquemers 803 was sorted according to the number of uniquemers identified in each protein sequence.

FIG. 8b tabulates the uniquemer residues and pScores identified for the D13L protein sequence of Variola India 1967. The amino acid symbols of the residues in the D13L protein sequence are displayed in the second column of the table. The position of each residue in the D13L protein sequence is displayed in the first column of the table. In the table, pScores are displayed in three different windows and shaded according to three different cutoff criteria. Window 4 displays normalized pScores calculated using 4-mers that are higher than a cutoff value of the 15^{th} percentile of all pScores (0.47) in light gray. Window 5 displays normalized pScores calculated using 5-mers that are higher than a cutoff value of the 15^{th} percentile of all pScores (0.52) in light gray. Window 6 displays normalized pScores calculated using 6-mers that are higher than a cutoff value of the 15^{th} percentile of all pScores (0.76) in light gray. The residues which are in subsequences of D13L identified to be uniquemers are indicated in dark gray in the column labeled ‘Uniquemer Overlap’. Using the visualization of normalized pScore and uniquemer residues in FIG. 8b, protein signatures comprising uniquemer residues with high pScores can be identified.

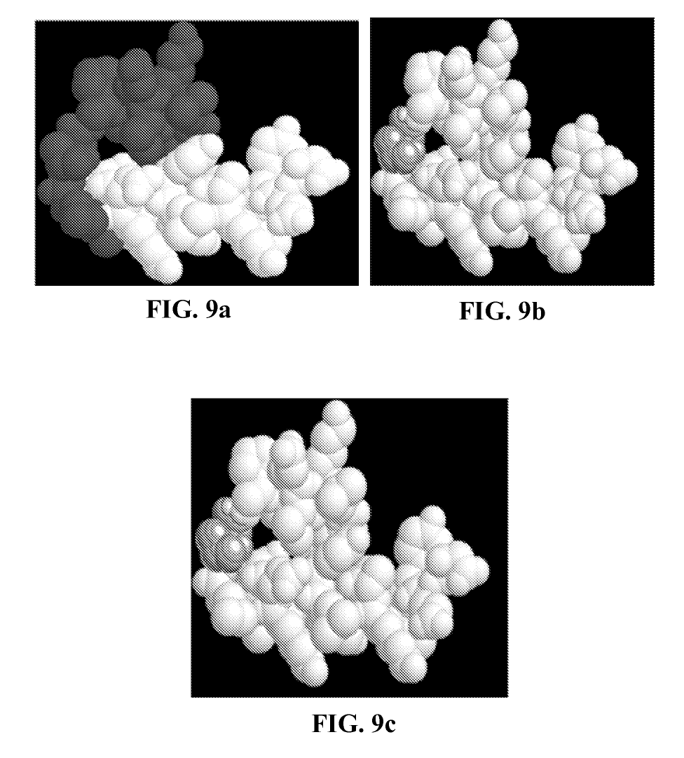

FIGS. 9a-9c illustrate identified uniquemers, pScores and protein signatures relative to the three-dimensional protein structure of the D13L protein of Variola India 1967. The protein structure of D13L was modeled using the homology-based protein structure modeling system AS2TS (Zemla et al., 2005). The uniquemer residues and residues with pScores calculated using 4-mers that are within the top 15^{the} percentile of the calculated pScores (tabulated in FIG. 8b) are visualized on the surface of three-dimensional protein structure. In FIG. 9a, the residues with normalized pScores within the top 15^{th} percentile of calculated pScores are shaded in gray on the D13L protein structure. In FIG. 9b, uniquemer residues are shaded in gray on the D13L protein structure. In FIG. 9c, protein signatures comprising uniquemer residues with pScores within the top 15^{th} percentile of calculated pScores are shaded in gray.

Visualization of surface-exposed regions comprising uniquemer residues was facilitated using RasMol (Sayle and Milner-White, 1995) to color uniquemer residues. Uniquemers and residues with pScores above the specified threshold value were loaded into the b-factor column of the reference D13L three-dimensional coordinates file and displayed using RasMol's color-temperature setting.

### Residue Substitutions

In addition to evaluating the frequency of perfect matches, the pScore Module 215 may incorporate the use of mismatches or gapped alignments can be used to score the relative frequency of a sequence. The substitutions allowed in the mismatch can be defined by substitutions matrices and allowable substitutions based on protein groupings or alphabets. Those of ordinary skill in the art having the benefit of the instant disclosure can envision a variety of other comparable methods of defining allowed residue substitutions.

Substitution matrices represent the rate at which each possible residue in a sequence changes to each other residue over time. Substitution matrices are 20 by 20 matrices containing preferred substitutions propensity for all possible pairs of amino acids. The preferred substitution propensities may be calculated based on a set of homologous sequences or many sets of homologous sequences. Two substitution matrices for amino acids commonly used in the art are PAM (Point Accepted Mutation) and BLOSUM (IMO& SUbstitution Matrix). Substitution matrices may also be used to create a grouping such as above by identifying the grouping of amino acids which minimizes the off diagonal elements in the substitution matrix (Fygenson et al., 2004).

In another embodiment of the present invention, the pScore module 215 generates occurrence frequencies according to a set of allowable substitutions specified by pre-defined groupings based on amino acid characteristics. One method of grouping the 20 known amino acids is by chemistry and size: aliphatic (AGILPV), aromatic (FWY), acidic (DE), basic (RKH), small hydroxylic (ST), sulfur-containing (CM) and amidic (NQ).

Other grouping schemes are based on functional properties such as: acidic (DE); basic (RKH); hydrophobic non polar (AILMFPWV); and polar uncharged (NCQGSTY). An example of a grouping scheme based on the charge of amino acid is: acidic (DE); basic (RKH) and neutral (AILMFPWV NCQGSTY). A grouping scheme based on structural properties is: ambivalent (ACGPSTWY); external (RNDQEHK); internal (ILMFV) (Karlin and Ghandour, 1985).

Other grouping schemes based on physical properties such as codon degeneracy or kinetic properties can also be employed to specify allowable substitutions.

### Protein Structure Modeling

The protein structure used to display the scored residues may be determined in a variety of methods. Protein structures are sets of solved atomic co-ordinates representative of a three-dimensional structure of a protein. These coordinates are solved for atoms including, but not limited to, alpha carbons, beta carbons, or side chain atoms. These sets of solved atom coordinates can also represent some substructure of a protein or polypeptide. Atomic coordinates can be solved experimentally using a variety of techniques such as x-ray crystallography, electron crystallography and nuclear magnetic resonance.

Despite the accuracy of experimental techniques, they are costly and time-consuming. Advances in protein structure prediction or modeling provide methods of computationally predicting the set of atom coordinates for a given protein. Protein structure prediction methods are generally classified based on three different techniques (sequence comparison, threading and ab initio modeling). Protein structure prediction or modeling is usually practiced as a combination of these techniques.

A favored method in the art of protein structure prediction is to find a close homolog for whom the structure is known. CASP (Critical Assessment of Techniques for Protein Structure Prediction) (Moult et al., 2003) experiments have shown that protein structure prediction methods based on homology search techniques are still the most reliable prediction methods. Sequence comparison and threading techniques are based on homology search.

Sequence comparison approaches to protein structure prediction are popular due to availability of protein sequence information. These techniques use conventional sequence search and alignment techniques such as BLAST or FASTA to assign protein fold to the query sequence based on sequence similarity.

Approaches which use protein profiles are similar to sequence-sequence comparisons. A protein profile is an n-by-20 substitution matrix where n is the number of residues for a given protein. The substitution matrix is calculated via a multiple sequence alignment of close homologs of the protein. These profiles may be searched directly against sequence or compared with each other using search and alignment techniques such as PSI-BLAST and HMMer.

It is known that sequence similarity is not necessary for structural similarity. Proteins sharing similar structure can have negligible sequence similarity. Convergent evolution can drive completely unrelated proteins to adopt the same fold. Accordingly, ‘threading’ methods of protein structure prediction were developed which use sequence to structure alignments. In threading methods, the structural environment around a residue could be translated into substitution preferences by summing the contact preferences of surrounding amino acids. Knowing the structure of a template, the contact preferences for the 20 amino acids in each position can be calculated and expressed in the form of an n-by-20 matrix. This profile has the same format as the position-specific scoring profile used by sequence alignment methods, such as PSI-BLAST, and can be used to evaluate the fitness of a sequence to a structure.

Ab initio methods are aimed at finding the native structure of the protein by simulating the biological process of protein folding. These methods perform iterative conformational changes and estimate the corresponding changes in energy. Ab initio methods are complicated by the inaccurate energy functions and the vast number of possible conformations a protein chain can adopt. The most successful approaches of ab initio modeling include lattice-based simulations of simplified protein models and methods building structures from fragments of proteins. Ab initio methods demand substantial computational resources and are also quite difficult to use and expert knowledge is needed to translate the results into biologically meaningful results. Despite known limitations, Ab initio methods are increasingly applied in large-scale annotation projects, including fold assignments for small genomes. Recent examples of such applications include: Bonneau et al. 2001, Kuhlman et al. 2003 and Dantas et al. 2003.

In practice, protein structure prediction typically involves a combination of the listed techniques, both experimental and computational. Hybrid approaches to protein structure prediction involve using different techniques for solving the atom coordinates at different stages or to solve for different parts of the protein structure. An example of this would be the use of AS2TS (amino acid to tertiary structure, a homology modeling technique) to facilitate the molecular replacement (MR) phasing technique in experimental X-ray crystallographic determination of the protein structure of Mycobacterium tuberculosis (MTB) Rm1C epimerase (Rv3465) from the strain H37rv. The AS2TS system was used to generate two homology models of this protein that were then successfully employed as MR targets.

Meta-predictors or consensus approaches attempt to benefit from the diversity of models by combining multiple techniques. In these methods, predictive models are collected and analyzed from a variety of different computational and experimental techniques. A common approach for combining models by consensus is to select the most abundant fold represented in the set of high scoring models. Other approaches to consensus modeling involve structural clustering such as HCPM-Hierarchical Clustering of Protein Models (Gront and Kolinski, 2005).

In one embodiment of the present invention the protein structures are predicted using the AS2TS program. The AS2TS system uses homology modeling to translate sequence-structure alignment data into atom coordinates. For a given sequence of amino acids, the AS2TS (amino acid sequence to tertiary structure) system calculates (e.g., using PSI-BLAST analysis of PDB) a list of the closest proteins from the PDB, and then a set of draft 3D models is automatically created.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims. All references disclosed in this specification, including references to books, scientific articles, patent applications, patents, and other publications are incorporated by reference in their entirety for all purposes.

### REFERENCES

Zhou, C E, A Zemla, D Roe, M Young, M Lam, J S Schoeniger, and R Balhorn. 2005. Computational approaches for identification of conserved/unique binding pockets in the A chain of ricin. Bioinformatics 21:3085-3096
Rost, B., Liu, J. (2005) The PredictProtein server. Nucleic Acids Res. 2003 Jul. 1; 31(13):3300-4.
Gront D., Kolinski A., HCPM—program for hierarchical clustering of protein models. Bioinformatics. July 15; 21(14):3179-80. Epub 2005 Apr. 19.
Moult, J., Fidelis, K., Zemla, A. (2003) Hubbard T., Critical assessment of methods of protein structure prediction (CASP)-round V., Proteins.; 53 Supp 16:334-9.
Prager, E. M., Wilson, A. C. (1978) Construction of phylogenetic trees for proteins and nucleic acids: empirical evaluation of alternative matrix methods. J Mol Evol. June 20; 11(2):129-42.
Bonneau, R., Tsai, J., Ruczinski, I. and Baker, D. (2001) Functional inferences from blind ab initio protein structure predictions. J. Struct. Biol., 134, 186-190.
Kuhlman, B., Dantas, G., Ireton, G. C., Varani, G., Stoddard, B. L. and Baker, D. (2003) Design of a novel globular protein fold with atomic-level accuracy. Science, 302, 1364-1368. 61.
Dantas, G., Kuhlman, B., Callender, D., Wong, M. and Baker, D. (2003) A large scale test of computational protein design: folding and stability of nine completely redesigned globular proteins. J. Mol. Biol., 332, 449-460.
Attwood, T. K., Avison, H., Beck, M. E., Bewley, M., Bleasby, A. J., Brewster, F., Cooper, P., Degtyarendko, K., Geddes, A. J., Flower, D. R., Kelly, M. P., Lott, S., Measures, K. M., Parry-Smith, D. J., Perkins, D. N., Scordis, P., Scott, D., and Worledge, C. (1997) The PRINTS database of protein fingerprints: A novel information resource for computational molecular biology. J Chem Inf Comput Sci, 37, 417-424.
Berman, H. M., Westbrook, J., Feng, Z., Gilliland, G., Bhat, T. N., Weissig, H., Shindyalov, I. N., and Bourne, P. E. (2000) The protein data bank. Nucleic Acids Research, 8, 235-242.
Bower, M. J., Cohen, F. E. and Dunbrack, R. L. (1997) Prediction of protein side-chain rotamers from a backbone-dependent rotamer library: a new homology modeling tool. J Mol Biol, 267, 1268-1282.
Canutescu A. A., Shelenkov A. A. and Dunbrack, R. L. (2003) A graph theory algorithm for protein side-chain prediction. Prot Sci, 12, 2001-2014.
Day, P. J., Ernst, S. R., Frankel, A. E., Monzingo, A. F., Pascal, J. M., Molina-Svinth, M. C. and Robertus, J. D. (1996) Structure and activity of an active site substitution of ricin A chain. Biochemistry, 35, 11098-11103.
Ewing, T. J. A., S. Makino, A. G. Skillman, I. D. Kuntz. 2001. DOCK 4.0: Search strategies for automated molecular docking of flexible molecule databases. Journal of Computer-Aided Molecular Design 15: 411-428.
Fygenson, D. K., Needlemen, D. J. and Sneppen, K. (2004) Variability-based sequence alignment identifies residues responsible for functional differences in a and b tubulin. Protein Science, 13, 25-31.
Gabdoulkhakov, A. G., Savochkina, Y., Konareva, N., Krauspenhaar, R., Stoeva, S., Nikonov, S. V., Voelter, W., Betzel, C., Mickhailov, A. M.. Structure-Function Investigation Complex of Agglutinin from Ricinus Communis with Galactoaza (to be published).
Gardner, S., Lam, M. W., Mulakken, N. J., Torres, C. L., Smith, J. R. and Slezak, T. R. (2004) Sequencing needs for viral diagnostics. Journal of Clinical Microbiology, 42, 0095-1137.

### Hubbard, S. J. and Thornton, J. M. (1993) ‘NACCESS’, Computer Program, Department of Biochemistry and Molecular Biology, University College, London.

Karlin, S. and Ghandour, G. (1985) Multiple-alphabet amino acid sequence comparison of the immunoglobulin k-chain constant domain. Proc. Natl. Acad. Sci. USA, 82, 8597-8601.
Knight, B. (1979) Ricin—a potent homicidal poison. British Medical Journal, 278, 350-351.
Kuntz, I. D., Blaney, J. M., Oatley, S. J., Langridge, R. and Ferrin, T. E. (1982) A geometric approach to macromolecule-ligand interactions. J. Mol. Biol., 161, 269-288.
Lebeda, F. J. and Olson, M. A. (1999) Prediction of a conserved, neutralizing epitope in ribosome-inactivating proteins. International Journal of Biological Macromolecules, 24, 19-26.
Lightstone, F. C., Prieto, M. C., Singh, A. K., Piqueras, M. C., Whittal, R. M., Knapp, M. S., Balhorn, R. and Roe, D. C. (2000) Identification of novel small molecule ligands that bind to tetanus toxin. Chem Res Toxicol., 13, 356-362.
Lord, J.. M., Roberts, L. M. and Robertus, J. D. (1994) Ricin: structure, mode of action, and some current applications. FASEB J, 8, 201-208.
Marsden, C. J., Fulop, V., Day, P. J and Lord, J. M. (2004) The effects of mutations surrounding and within the active site on the catalytic activity of ricin A chain. Eur. J. Biochem., 271, 153-162. 12
Olson, M. A., Carra, J. H., Roxas-Duncan, V., Wannemacher, R. W., Smith, L. A., and Millard, C. B. (2004) Finding a new vaccine in the ricin protein fold. Protein Engineering, Design & Selection, 17, 391-397.
Olsnes, S. and Kozlov, J. V. (2001) Ricin. Toxicon 39:1723-1728.
Ouzounis, C. A., Coulson, R. M., Enright, A. J., Kunin, V., Pereira-Leal, J. B. (2003) Classification schemes for protein structure and function. Nat Rev Genet., 4, 508-519.
Peruski, A. H., and Peruski, Jr, L. F.. (2003) Immunological methods for detection and identification of infectious disease and biological warfare agents. Clinical and Diagnostic Laboratory Immunology, 10, 506-513.
Portefaix, J.-M., S. Thebault, F. Bourgain-Guglielmetti, M. D. Del Rio, C. Granier, J.-C. Mani, I. Navarro-Teulon, M. Nicolas, T. Soussi, and B. Pau. 2000. Critical residues of epitopes recognized by several anti-p53 monoclonal antibodies correspond to key residues of p53 involved in interactions with the mdm2 protein. Journal of Immunological methods 244: 17-28.
Sayle, R. A. and Milner-White, E. J.. 1995. RasMol: Biomolecular graphics for all. Trends in Biochemical Sciences, 20, 374-376.

### Shuker, S. B., Hajduk, P. J., Meadows, R. P. and Fesik, S. W. (1996) Discovering High-Affinity Ligands for Proteins: SAR by NMR. Science, 274, 1531-1534.

Slezak, T., Kuczmarski, T., Ott, L., Torres, C., Medeiros, D., Smith, J., Truitt, B., Mulakken, N., Lam, M., Vitalis, E., Zemla, A., Zhou, C. E. and Gardner, S. (2003) Comparative genomics tools applied to bioterrorism defense. Briefings in Bioinformatics, 4, 133-149.
Wang, G., De, J., Schoeniger, J. S., Roe, D. C. and Carbonell, R. G. (2004) A hexamer peptide ligand that binds selectively to staphylococcal enterotoxin B: isolation from a solid phase combinatorial library. Journal of Peptide Research, 64, 51-64.
Wesche, J., Rapak, A. and Olsnes, S. (1999) Dependence of ricin toxicity on translocation of the toxin A-chain from the endoplasmic reticulum to the cytosol. J Biol Chem, 274, 34443-34449.
Weston, S. A., Tucker, A. D., Thatcher, D. R., Derbyshire, D. J. and Pauptit, R. A. (1994) Xray structure of recombinant ricin A-chain at 1.8 Å resolution. J. Mol Biol., 244, 410-422.
Yan, X., Hollis, T., Svinth, M., Day, P., Monzingo, A. F., Milne, G. W., Robertus, J. D. (1997) Structure-based identification of a ricin inhibitor. J Mol Biol, 266, 1043.
Zemla, A. (2003) LGA: a method for finding 3D similarities in protein structures. Nucleic Acid Research, 31, 3370-3374.
Zemla, A., Ecale Zhou, C., Slezak, T., Kuczmarski, T., Rama, D., Torres, C, Sawicka, D. and Barsky, D. (2005) AS2TS system for protein structure modeling and analysis. Nucleic Acids Research, 1; 33(Web Server issue):W111-5.

1. A method of selecting a set of protein signature residues for an organism, the method comprising:
identifying a set of known protein sequences associated with an organism, wherein each known protein sequence comprises a plurality of ordered residues;
identifying a set of scores associated with a set of residues of the plurality of ordered residues, wherein each score indicates a frequency of a residue in sequence context;
identifying a set of unique sub-sequences of the set of known protein sequences; and
determining a plurality of protein signature residues based on the set of scores associated with the set of residues and the set of unique sub-sequences.

2. The method of claim 1, wherein the organism is a pathogen.

3. The method of claim 1, wherein the set of known sequences comprises a majority of known protein sequences associated with the organism.

4. The method of claim 1, wherein determining a plurality of protein signature residues further comprises:
identifying a subset of the set of residues comprising the set of unique sub-sequences.

5. The method of claim 4, wherein the subset of the set of residues are associated with scores above a threshold value.

6. The method of claim 4, wherein determining the plurality of protein signature residues further comprises displaying the subset of the set of residues on a three-dimensional representation of a protein sequence comprising the subset of the set of residues.

7. The method of claim 4, wherein determining the plurality of protein signature residues further comprises identifying that the subset of the set of residues are proximal in three-dimensional space based on the three-dimensional representation of the protein sequence.

8. The method of claim 1, wherein each unique sub-sequences of the set of unique-subsequences comprises at least 4 residues.

9. A computer-readable storage medium encoded with executable program code for selecting a set of protein signature residues for an organism, the program code comprising program code for:
identifying a set of known protein sequences associated with an organism, wherein each known protein sequence comprises a plurality of ordered residues;
identifying a set of scores associated with a set of residues of the plurality of ordered residues, wherein each score indicates a frequency of a residue in sequence context;
identifying a set of unique sub-sequences of the set of known protein sequences; and
determining a plurality of protein signature residues based on the set of scores associated with the set of residues and the set of unique sub-sequences.

10. The medium of claim 9, wherein the organism is a pathogen.

11. The medium of claim 9, wherein the set of known sequences comprises a majority of known protein sequences associated with the organism.

12. The medium of claim 9, wherein program code for determining a plurality of protein signature residues further comprises:
identifying a subset of the set of residues comprising the set of unique sub-sequences.

13. The medium of claim 12, wherein the subset of the set of residues are associated with scores above a threshold value.

14. The medium of claim 12, wherein program code for determining the plurality of protein signature residues further comprises program code for displaying the subset of the set of residues on a three-dimensional representation of a protein sequence comprising the subset of the set of residues.

15. The medium of claim 12, wherein program code for determining the plurality of protein signature residues further comprises program code for identifying that the subset of the set of residues are proximal in three-dimensional space based on the three-dimensional representation of the protein sequence.

16. The medium of claim 9, wherein each unique sub-sequences of the set of unique-subsequences comprise at least 4 residues.
